(19) United States
(12) Patent Application Publication
(10) Pub. No.: US 2025/0178062 A1
(43) Pub. Date: Jun. 5, 2025

(54) MODULAR ATTACHMENTS FOR A PLANISHING HAMMER

(71) Applicants: Theodore Allen Buresh, Blair, WI (US); Noah Amyas Buresh, Blair, WI (US)

(72) Inventors: Theodore Allen Buresh, Blair, WI (US); Noah Amyas Buresh, Blair, WI (US)

(21) Appl. No.: 18/965,713

(22) Filed: Dec. 2, 2024

Related U.S. Application Data
(60) Provisional application No. 63/604,789, filed on Nov. 30, 2023.

(51) Int. Cl. B21D 31/06; B25D 17/24

(52) U.S. Cl. CPC B21D 31/06; B25D 17/24; B25D 2217/0015; B25D 2217/0073; B25D 2222/21

(57) ABSTRACT

The present invention introduces a system of modular attachments for planishing hammers and pistol-style air hammer/chisels, significantly enhancing their functionality and versatility in metalworking applications. The modular system includes three specialized attachments: the stepper, for creating precise stepped profiles; the flanger, for forming reinforced edges and flanges; and the shrinker/stretcher, for shaping complex curves through controlled shrinking and stretching. Each attachment integrates seamlessly with the tools via an attachment interface, designed for secure installation, rapid replacement, and ergonomic adaptability. The attachments can be used individually or in combination, offering precision and efficiency for tasks in automotive restoration, aerospace fabrication, artistic metalworking, and more. The invention also includes an innovative interface for use with handheld planishing hammers or air-powered chisels, enabling portable and powerful performance. By expanding the range of operations achievable with a single tool, this invention provides a versatile, efficient, and precise solution for modern metalworking.

### RELATED APPLICATION

This application claims the benefit of U.S. (Provisional) Application No. 63/604,789, filed on Nov. 30, 2023, which is hereby incorporated herein by reference.

### BACKGROUND OF THE INVENTION

The present invention relates to planishing hammers and, more particularly, to modular attachments designed to enhance the functionality and versatility of handheld planishing hammers. The invention introduces three distinct attachments: the stepper, the flanger, and the shrinker/stretcher, each tailored to perform specialized metalworking tasks. These attachments enable a handheld planishing hammer to execute operations such as stepping, flanging, shrinking, and stretching with precision and efficiency.

Planishing hammers are well-established tools in metalworking, employed to smooth, shape, and refine sheet metal surfaces through repetitive, controlled impacts. Traditionally, these hammers have been available as stationary units or handheld devices. Stationary planishing hammers, while effective, require operators to manipulate the metal into position under the hammering mechanism, which can be cumbersome and restrictive. Handheld planishing hammers overcome this limitation by allowing greater mobility and flexibility. However, such tools typically lack the adaptability needed to perform more complex operations, such as stepping, flanging, shrinking, and stretching.

The limitations of existing handheld planishing hammers necessitate the use of multiple tools or custom solutions, which can result in inefficiencies, increased costs, and inconsistent results. This is particularly problematic in fields that demand precision and versatility, such as automotive restoration, aerospace fabrication, and metal artistry. Therefore, there is a pressing need for modular attachments that can transform handheld planishing hammers into versatile tools capable of handling a broader range of operations.

The present invention addresses this need by introducing three modular attachments—the stepper, the flanger, and the shrinker/stretcher—that are specifically designed to perform distinct metalworking functions. Each attachment can be easily installed on a planishing hammer, significantly expanding its capabilities and enhancing its utility for both professional and hobbyist users.

### SUMMARY OF THE INVENTION

The present invention relates to a modular attachment system for planishing hammers and air-powered chisels, designed to enhance their functionality and versatility in performing specialized metalworking tasks. The invention comprises an attachment interface that securely connects modular attachments to the tool, ensuring precise alignment and stability during operation.

The modular attachments include a stepper attachment configured to create stepped profiles in sheet metal, comprising a ridged die for forming steps, an adjustable edge depth guide to control the step depth, and a housing for alignment and support. A flanger attachment is also included, configured to form flanges in sheet metal, featuring curved dies of varying radii, a rotary guide rail mechanism, and an adjustable angle mechanism to control flange formation. Additionally, the system includes a shrinker/stretcher attachment configured to modify the surface area of sheet metal, incorporating interchangeable dies for shrinking and stretching, a quick-swap mechanism for die replacement, and a support assembly for securing the dies.

The attachment interface is adaptable to various planishing hammers and air-powered chisels, accommodating differences in size and shape through a locking mechanism. It is designed to maintain stability during high-frequency operation and may include vibration-dampening elements to reduce wear and improve operator comfort. The modular design enables rapid attachment changes, allowing users to transition efficiently between tasks.

By addressing the limitations of conventional tools, the invention provides a versatile and efficient system capable of performing complex operations such as stepping, flanging, shrinking, and stretching. This modular attachment system offers significant advantages for applications in automotive restoration, metal artistry, aerospace fabrication, and other precision metalworking fields, delivering a flexible and user-friendly solution to meet modern metalworking challenges.

Additional aspects of the present invention will be apparent in view of the description which follows.

### BRIEF DESCRIPTION OF THE FIGURES

FIG. 1 is a left side elevation view of a planishing hammer.

FIG. 2 is a left side elevation cut away view of a planishing hammer.

FIG. 3 is a left side elevation view of the stepper attachment and attachment interface connected to a planishing hammer. interface.

FIG. 4 is a right side elevation view of the stepper attachment and attachment

FIG. 5 is a perspective view, shown from the top left, of the stepper attachment.

FIG. 6 is a perspective view, shown from the top right, of the stepper attachment and attachment interface.

FIG. 7 is a perspective view, shown from the bottom left, of the stepper attachment.

FIG. 8 is a perspective view, shown from the bottom right, of the stepper attachment.

FIG. 9 is a left side elevation view of the flanger attachment and attachment interface connected to a planishing hammer.

FIG. 10 is a right side elevation view of the flanger attachment.

FIG. 11 is a perspective view, shown from the top left, of the flanger attachment.

FIG. 12 is a perspective view, shown from the top right, of the flanger attachment and attachment interface.

FIG. 13 is a perspective view, shown from the bottom left, of the flanger attachment.

FIG. 14 is a top elevation view of the flanger attachment.

FIG. 15 is a right side elevation view of the shrinker/stretcher attachment and attachment interface.

FIG. 16 is a schematic perspective view of the shrinking die mechanism.

FIG. 17 is a schematic perspective view of the stretching die mechanism.

FIG. 18 is a schematic left side elevation cut away view of another attachment interface to a pistol style air hammer/chisel.

### DETAILED DESCRIPTION OF THE INVENTION

The present invention addresses the limitations of conventional planishing hammers by introducing a system of modular attachments that significantly enhance their versatility and utility in metalworking. These attachments—comprising the stepper 60, the flanger 70, and the shrinker/stretcher 90—are specifically designed to perform a wide range of specialized tasks, including stepping, flanging, shrinking, and stretching. By enabling a single tool to execute operations typically requiring multiple tools, the invention simplifies the workflow for both professional and hobbyist metalworkers. The stepper 60, the flanger 70, and the shrinker/stretcher 90 tools can also be offered as a unitized construction with a power source, or as a system of modular attachments.

Central to the invention is an innovative attachment interface 50 that allows these modular components to be securely and seamlessly integrated with planishing hammers 30 and pistol style air hammer/chisels 120. This interface is engineered for compatibility with a variety of hammer models, ensuring ease of installation, precision alignment, and ergonomic adaptability. The modular design facilitates rapid attachment changes, enabling users to transition between tasks efficiently and with minimal downtime.

Each attachment is carefully designed to address specific challenges in metalworking. The stepper 60 creates precise stepped profiles for structural reinforcement and alignment; the flanger 70 forms clean, accurate flanges to strengthen edges and create overlaps; and the shrinker/stretcher 90 provides dual functionality for shaping complex curves by compressing or expanding metal surfaces. Together, these attachments transform the planishing hammer into a multifunctional tool, capable of handling intricate and demanding tasks with precision and ease.

The following detailed description provides an in-depth explanation of the components, functionality, and advantages of the modular attachment system. Particular emphasis is placed on the attachment interface, the unique design of each modular component, and the methods by which the system enhances the performance of planishing hammers 30 and pistol style air hammer/chisels 120. By addressing the specific needs of modern metalworking, this invention offers an efficient, adaptable, and high-precision solution for a wide range of applications.

The attachment interface plays a critical role in ensuring the seamless integration of the modular attachments with planishing hammers 30 and pistol style air hammer/chisels 120. The interface is designed to be universally compatible with a variety of hammer models, allowing users to retrofit the stepper 60, flanger 70, and shrinker/stretcher 90 attachments onto their existing tools without requiring extensive modifications. This universality is achieved through multi fasteners connecting the attachment to the base plate 34 of a planishing hammer 30 or in another embodiment a combination of a locking collar and an adjustable clamping mechanism, which securely fastens the attachment to the hammer 30 or pistol 120 while accommodating variations in hammer 30 or pistol 120 head sizes and shapes.

The locking collar can be constructed from high-strength, lightweight materials such as aluminum alloy or hardened steel, ensuring durability while maintaining portability. The collar incorporates a quick-release mechanism, typically a chuck, thread, lever or button. Allowing the operator to install or remove attachments rapidly without the use of additional tools. This feature minimizes downtime during operations and enhances workflow efficiency, particularly in applications that require frequent switching between tasks.

In one embodiment to ensure precision alignment, the attachment interface 50 includes a self-centering guide that aligns the attachment with the hammer's striking axis. The guide can be in the form of the hole for hammer head 38, mounting screw holes 44, adjusting screw hole 45, or other means, located on the top or sides a base plate 34. This guide prevents misalignment during operation, which could compromise the quality of the finished workpiece. In addition, the interface is equipped with vibration-dampening elements, such as rubber gaskets or polymer inserts, to reduce wear on the hammer and attachment while providing smoother operation for the user.

The interface design also incorporates adjustability to accommodate the ergonomic needs of the operator. For example, the angle and orientation of the attachment can be adjusted relative to the hammer, allowing the user to perform tasks in tight spaces or at challenging angles. This adaptability is particularly beneficial in artistic and automotive metalworking, where intricate and precise movements are often required.

The attachment interface is designed to withstand the high-frequency impacts generated by planishing hammers 30 and pistol style air hammer/chisels 120. Reinforced connection points and stress-relief features ensure the durability of the interface under prolonged use. The modular design also allows for easy maintenance, with replaceable components that extend the overall lifespan of the system.

This robust and versatile attachment interface transforms a conventional handheld planishing hammer 30 or pistol style air hammer/chisel 120 into a highly adaptable tool, capable of handling a wide range of complex metalworking tasks. By prioritizing ease of use, precision alignment, and ergonomic adaptability, the interface ensures that the modular attachments can be utilized effectively by professionals and hobbyists alike, regardless of the hammer model they own.

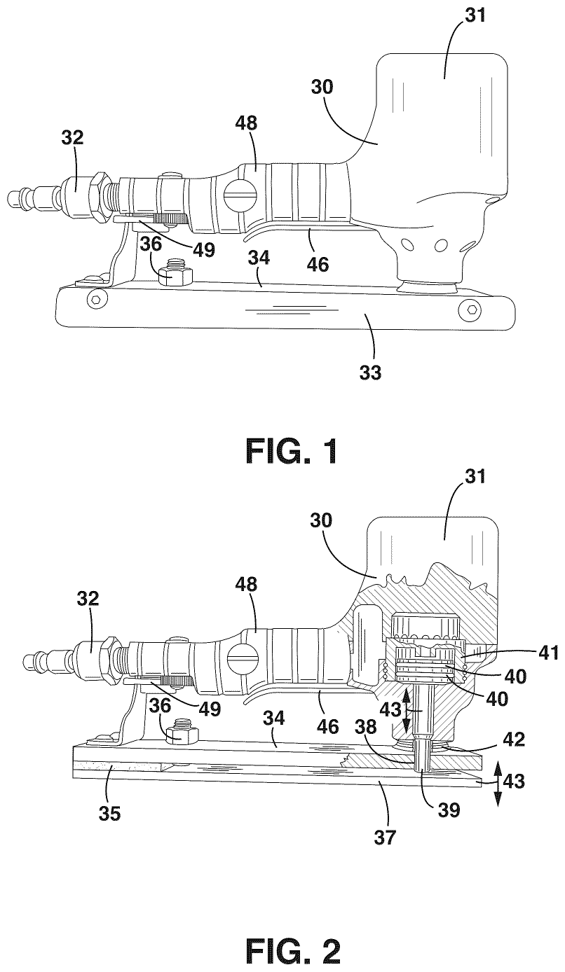

FIG. 1 is a left side elevation view of the planishing hammer 30 according to a preferred embodiment. As can be seen, the hammer 30 includes a power unit 31 and rail keeper 33/baseplate 34 housing that houses a slapper 37 pivotally coupled at the proximal end to the power unit 31. The power unit 31 generally provides vertical reciprocating up and down actuation of the slapper 37 toward the proximal end of the hammer 30 that hammers sheet metal placed under the slapper 37. The power unit 31 has a head portion at the distal end of the device 30 opposite the air supply port 32. Between the distal and proximal ends is a handle 48. The hammer 30 may be operated with a trigger or air control lever 46. Preferably, the lever 46 allows for the variable operation/speed of the power unit 31.

Referring to FIG. 2 a left side elevation cut away view of the planishing hammer 30 according to a preferred embodiment. As can be seen, the hammer power unit 31 is fixedly attached to the base plate 34 at the distal end with an L shaped bracket. At the proximal end, the power unit 31 may be fixed to the base plate 34. Alternatively, the unit 31 may be unrestrained at the distal end. In this regard, the base plate 34 is essentially cantilevered to the power unit 31 at the proximal end. A hammer sleeve 42 may form a seal between the power unit and the base plate 18 with the hammer head 39 disposed within the sleeve 42. At the proximal end, the slapper 37 is coupled to the unit 31 by means that allows the slapper 37 to move vertically at the distal end away from the unit 31 in response to one or more impacts or actuation by the hammer head 39 and return back to its initial position when the hammer head 39 retracts. In one embodiment, this is achieved by attaching the slapper 37 to base plate in a pivotal relationship with a spring material 35 there between. In one embodiment, the spring material 35 is an elastic sheet that deflects sufficiently to allow the slapper to move at the distal end while minimizing any deflection in the slapper 37. The return distance of the slapper may be controlled with adjustment nut 36. The dimensions of the slapper 37 may vary, depending on the desired flattening capability, however, to achieve at least some of the objectives, the distance between the pivoting point and the hammer head 39 is at least about 6 inches and up to about 12 inches or more.

Power unit 31 preferably has an inner cavity to house the movable fitting 41 and the hammer head 39 that reciprocates vertically with the application of air pressure and is connected to base plate 34 by hammer sleeve 42. Referring more particularly to hammer head 39 which has a symmetrical design constructed around a central vertical access it can be further described as follows. The upper portion is preferably a hollow cylinder measuring about 1.16 inches in diameter by about 0.48 inches in height and is circumscribed with two channels or grooves to hold O-rings 40.

In one embodiment of the planishing hammer 30, the slapper 37 could be absent or removable from the assembly. In this embodiment, the hammerhead 39 can contact a sheet metal surface 47 directly. Moreover, the hammerhead 39 may be interchangeable with other attachments for finishing and planishing sheet metal 47.

When engaged, with air pressure, the hammerhead 39 moves up and down 43 reciprocally, through the hole for hammer head 38 to move the slapper 37 in an up and down 43 vibratory manner to smooth and flatten sheet metal 47.

The stepper 60 attachment is designed to create precise stepped profiles in sheet metal. It includes a ridged die that applies controlled deformation to produce consistent offsets. The depth of the step can be adjusted through a built-in depth control mechanism, allowing the operator to customize the operation to suit specific requirements. The stepper 60 attachment is mounted onto the planishing hammer 30 using a attachment interface 50 that ensures secure installation and quick replacement. This attachment is particularly useful for applications such as joining metal panels and creating structural reinforcements.

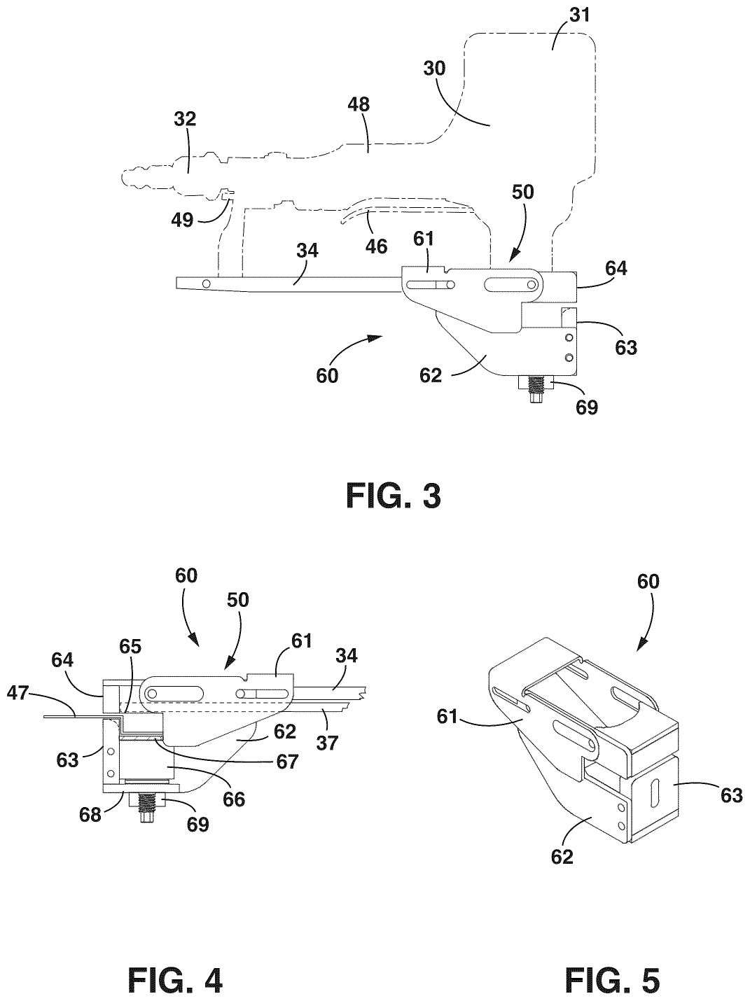

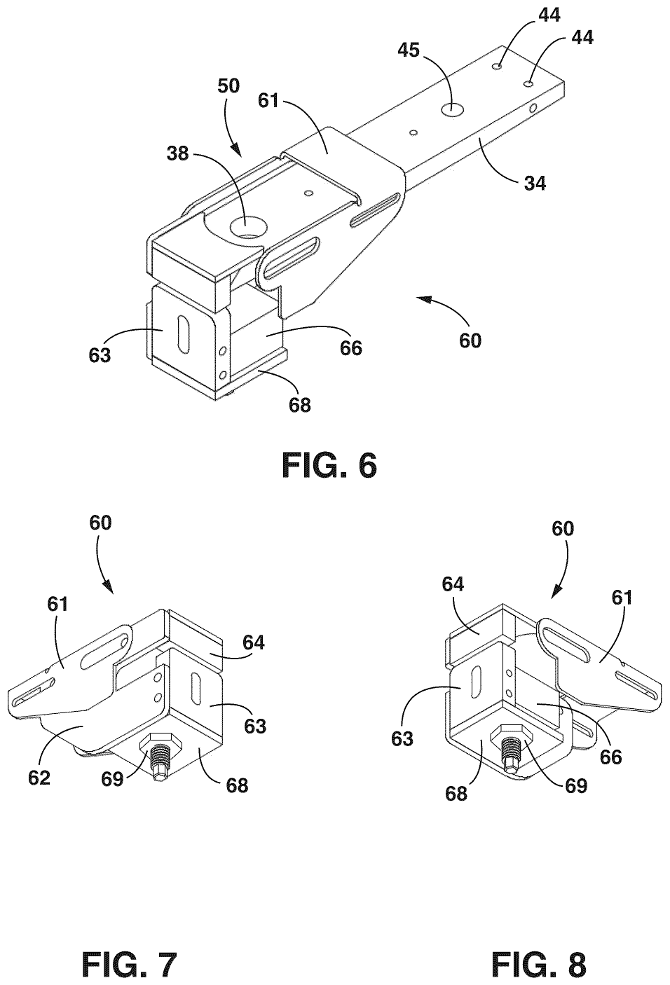

The stepper attachment 60 is configured to create precise stepped profiles in sheet metal, enabling accurate deformation for tasks such as joining panels or reinforcing structural elements. As illustrated in FIGS. 3 through 8, the stepper attachment 60 integrates multiple components designed to ensure precision, adaptability, and ease of use when attached to a planishing hammer 30 via an attachment interface 50.

A core feature of the stepper attachment 60 is its adjustable edge depth guide 61, which provides the operator with control over the depth of the steps created. The depth guide 61 is mounted adjacent to the stepper housing 62, which supports and aligns the attachment during operation. The depth guide 61 can be adjusted incrementally to accommodate varying thicknesses and dimensions of sheet metal, ensuring consistent and uniform results.

The stepper housing 62 is a robust structure designed to house the internal components and ensure alignment between the hammer's impact point and the sheet metal. The housing is machined from durable materials to withstand the repetitive impacts generated by the planishing hammer 30, while maintaining precise alignment for consistent performance.

The front anvil 63, which is interchangeable, plays a critical role in shaping the stepped profiles. The anvil can be radiused or flat, depending on the desired step shape and application requirements. This interchangeability allows for customization of the attachment to suit a range of metalworking tasks. To prevent unintended deformation of the material, the pressure plate 64 is included to hold the sheet metal firmly in place, ensuring that the deformation occurs only in the intended area.

To further enhance precision, the position of stopper front edge 65 can be adjusted, providing a physical barrier that ensures consistent step placement during repeated operations. The adjustable depth anvil guide 66 allows for fine-tuning of the anvil's position relative to the sheet metal, enabling the creation of highly accurate stepped profiles with controlled depth and spacing.

An optional feature, shown in FIGS. 4, is the facing 67, which can be composed of leather or plastic. This facing is positioned to prevent stretching of the material during the stepping process, ensuring that the shape and dimensions of the sheet metal remain consistent.

The bottom anvil is secured using a threaded plate 68, which allows for precise adjustment of its position. The plate is locked in place with a locking nut 69 to maintain stability during operation. The threaded plate 68 and locking nut 69 combination ensures that the bottom anvil remains securely positioned, even under the high-frequency impacts of the planishing hammer.

The stepper attachment 60 is connected to the planishing hammer 30 via the attachment interface 50, as shown in FIGS. 3, 4 and 6. This interface allows for secure installation while enabling rapid replacement or interchangeability with other modular attachments. The interface design ensures that the stepper remains firmly attached during operation, minimizing vibration and maintaining alignment.

The stepper attachment 60 offers significant utility in applications requiring precise alignment and consistent step profiles, such as panel joining or creating structural reinforcements. Its modular design, combined with adjustable and interchangeable components, enhances the versatility and precision of the planishing hammer 30 or pistol style air hammer/chisel 120, making it an essential tool for metalworkers.

The flanger attachment 70 is specifically designed for bending the edges of sheet metal to form flanges. It includes curved dies available in various radii, enabling the operator to create flanges of different sizes and angles. The attachment also features an adjustable angle mechanism, which allows for precise control over the bending process. Like the stepper 60, the flanger 70 attaches to the planishing hammer 30 or pistol style air hammer/chisel 120 through a universal attachment interface 50, ensuring ease of use and compatibility. This attachment is ideal for creating reinforced edges, overlaps, and components requiring tight bends.

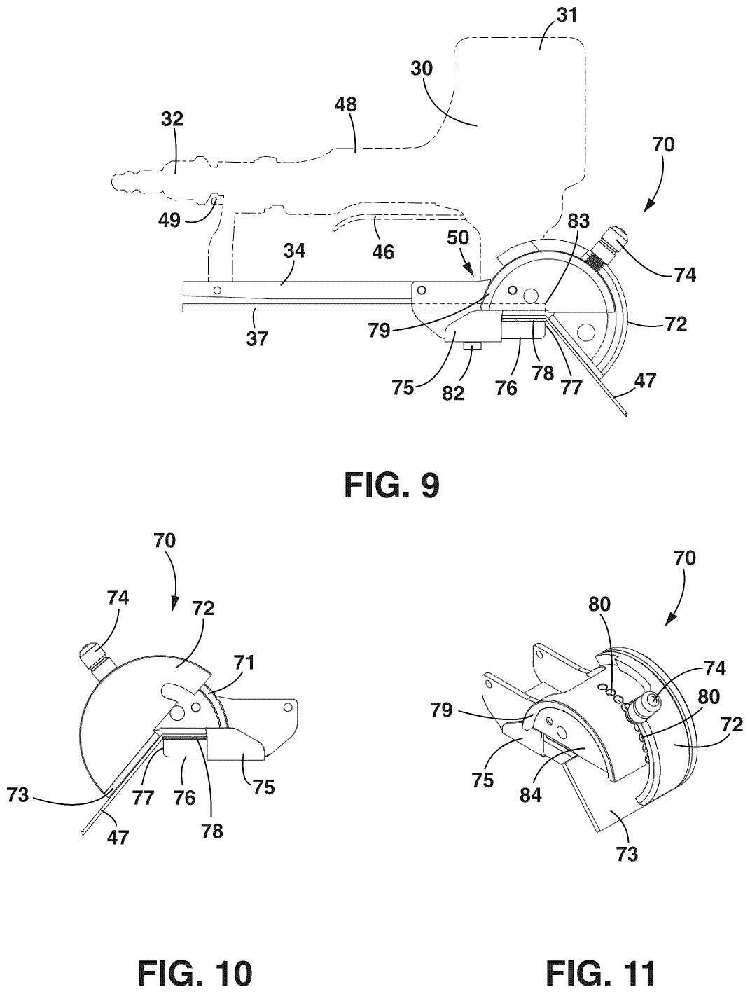

The flanger attachment 70 is designed to bend the edges of sheet metal to form flanges of varying sizes and angles, providing significant utility in creating reinforced edges, overlaps, and components requiring tight bends. As shown in FIGS. 9 through 14, the flanger attachment 70 integrates multiple precision components and mechanisms to ensure adaptability, precision, and ease of use. The attachment connects to a planishing hammer 30 or a pistol-style air hammer/chisel 120 via a attachment interface 50, ensuring compatibility across multiple tools.

Central to the flanger attachment 70 is the rotary guide rail slide mechanism 71, which facilitates smooth and controlled movement of the bending components along the edge of the sheet metal. This mechanism ensures consistent flange formation by guiding the metal through the bending process with precision. The rail is supported by the rotary guide rail 79, providing stability and alignment during operation.

The adjustable rotary pressure guide 72 plays a critical role in maintaining the integrity of the flange by preventing the edge from rounding during the bending process. This guide is equipped with a pressure plate 73, which applies consistent pressure to the sheet metal as it moves through the rotary guide rail slide mechanism 71. The pressure guide can be adjusted to accommodate different thicknesses and types of metal, ensuring versatility.

To enable precision adjustments, the flanger attachment 70 includes a spring-loaded adjusting pin 74. This pin allows the operator to modify the position of the rotary guide rail mechanism 71 quickly and easily, ensuring alignment with the edge of the sheet metal. Additionally, the edge adjusting guide 75 provides fine control over the placement of the metal, ensuring uniform flange formation along the entire edge.

The sheet metal is bent against a bending plate 76, which serves as a stable surface for forming the flange. The bending plate 76 is designed with a solid edge 77 to ensure consistent angles during the bending process. To prevent the metal from stretching or scratching, an insert 78, made of leather or plastic, is integrated into the plate. This insert provides a smooth surface for the sheet metal to slide against while maintaining its structural integrity.

The rotary guide mechanism features adjusting hole stops 80 along the rail 79, allowing the operator to set precise limits on the range of movement. These stops enhance repeatability for multiple flange operations, ensuring consistent results across a series of workpieces. A threaded hole 81 in the bending plate allows for the secure attachment of the lock screw for the edge adjusting guide 82, keeping the guide firmly in place during operation.

The bending operation is facilitated by the front edge of the slapper blade 83, which applies direct force to the metal, bending it against the solid edge 77 of the bending plate 76. This blade is guided by the rotary guide rail slide mechanism 84, ensuring smooth and controlled movement throughout the bending process.

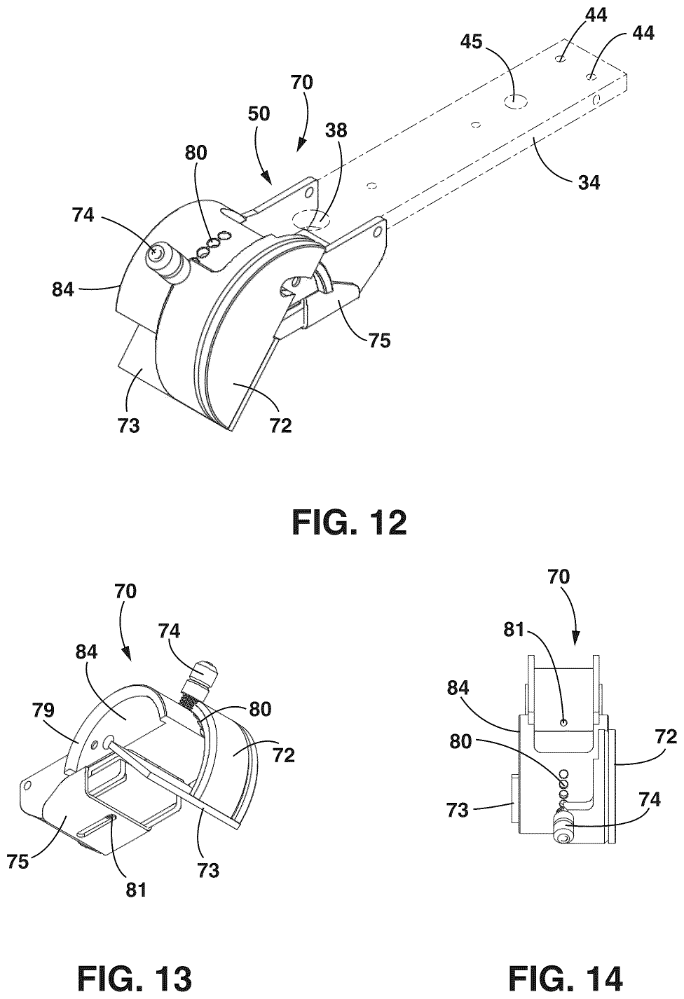

As shown in FIGS. 9 and 12, the flanger attachment 70 is connected to the planishing hammer 30 or pistol-style air hammer/chisel 120 via the universal attachment interface 50. This interface ensures secure installation while allowing for rapid attachment changes, enabling the operator to switch between the flanger attachment 70 and other modular components such as the stepper attachment 60. The interface's design minimizes vibration and maintains alignment during high-frequency operation.

The flanger attachment 70 provides operators with precise control over flange size, angle, and depth, making it an indispensable tool for tasks requiring reinforced edges and tight bends. Its robust design, adjustable components, and compatibility with multiple tools ensure reliability and versatility, addressing the diverse needs of modern metalworking.

The shrinker/stretcher 90 attachment combines the functionality of two tools in one. The shrinking function is achieved through a textured die that compresses the metal surface, reducing its area to create concave shapes. Conversely, the stretching function is facilitated by a smooth die that expands the metal surface, increasing its area to form convex shapes. A quick-swap mechanism allows the operator to switch between shrinking and stretching modes effortlessly. This attachment is mounted to the planishing hammer 30 via the same attachment interface 50, ensuring seamless integration. The shrinker/stretcher 90 is essential for shaping complex curves and contours in sheet metal, making it indispensable in applications such as automotive restoration and sculpture.

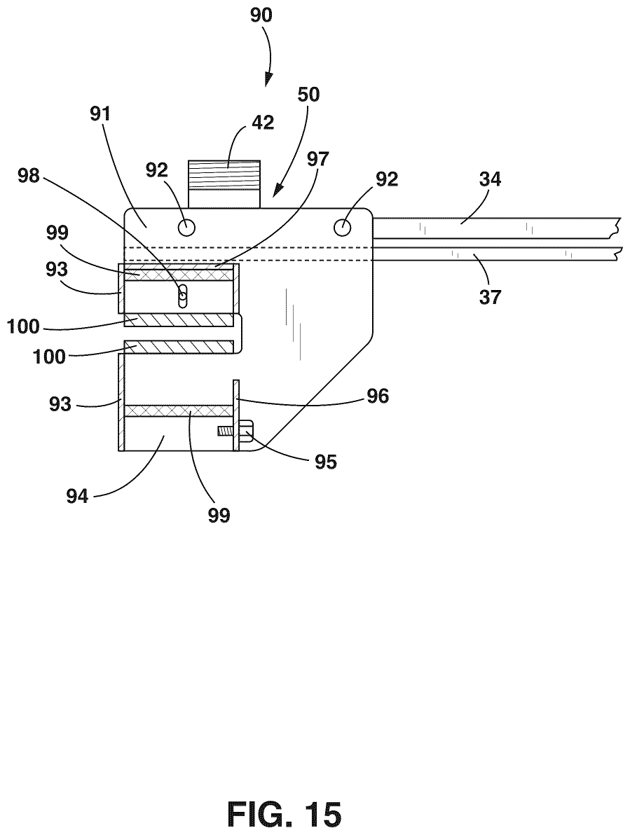

The shrinker/stretcher attachment 90 is a versatile tool designed to perform both shrinking and stretching operations on sheet metal. As shown in FIG. 15, the attachment integrates multiple precision-engineered components to achieve controlled deformation for creating concave and convex shapes. This dual functionality makes the shrinker/stretcher 90 indispensable for tasks such as forming complex curves and contours, particularly in automotive restoration and sculpture applications.

The attachment is built around a robust housing plate 91, which provides structural support and alignment for the internal components. The housing plate 91 is securely fastened to the planishing hammer 30 using mounting screws 92, ensuring stability during operation. This design ensures that the attachment remains firmly in place, even under the high-frequency impacts of the planishing hammer.

A front retaining plate 93 holds the top die in position, preventing displacement during operation. Below the front retaining plate 93, a bottoming plate 94 supports the sheet metal during deformation, providing a stable surface for consistent results. These components work together to guide and stabilize the material during shrinking and stretching processes.

The inside retaining plate for the bottom die 96 ensures that the bottom die remains securely positioned, allowing precise alignment with the top die. This plate is secured using the retaining plate lock screw 95, which prevents movement of the inside retaining plate 96 during operation. The lock screw 95 is adjustable, allowing for easy removal or replacement of the bottom die when necessary.

The top die itself is supported by a tool steel bucking plate 97, which absorbs the impact forces generated during operation, ensuring durability and precision. To facilitate die changes, the retaining pin for the top die 98 allows the operator to quickly remove and replace the top die without disrupting the overall setup.

The shrinking function is performed using a textured die, which compresses the metal's surface, reducing its area and creating concave shapes. Conversely, the stretching function employs a smooth die to expand the metal's surface area, forming convex shapes. A quick-swap mechanism incorporated into the design enables the operator to transition effortlessly between the shrinking and stretching modes, maximizing efficiency.

The attachment incorporates foam spring material 99, which provides controlled resistance during operation, ensuring smooth and consistent deformation. The foam spring material 99 also helps to absorb vibrations, enhancing operator comfort and reducing wear on the attachment components.

The shrinker/stretcher 90 is mounted to the planishing hammer 30 via the universal attachment interface 50. This interface ensures seamless integration with the hammer while allowing for rapid attachment changes. The secure connection provided by the interface minimizes vibration and misalignment, ensuring precise and reliable operation.

The shrinker/stretcher attachment 90 is an essential tool for shaping complex curves and contours in sheet metal. Its ability to combine shrinking and stretching functions in a single attachment streamlines workflows and eliminates the need for separate tools. By offering precision, durability, and ease of use, this attachment addresses the needs of modern metalworking professionals and hobbyists alike.

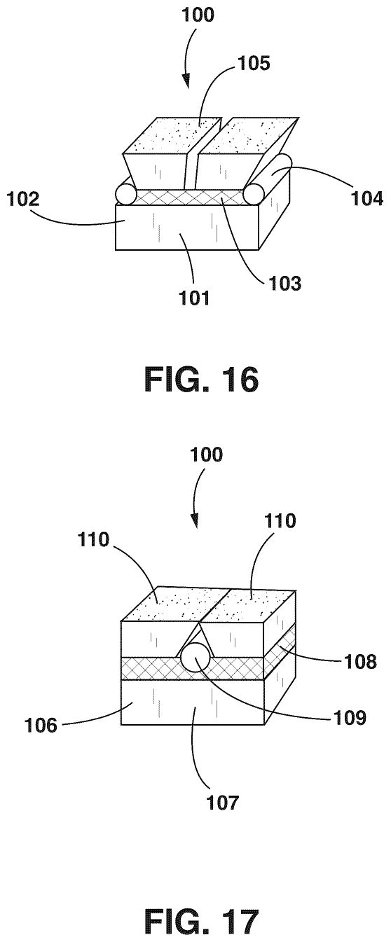

The shrinker/stretcher attachment 90 incorporates a system of shrink or stretch dies 100, which are interchangeable and versatile components designed to facilitate both shrinking and stretching operations. These dies can be used singularly or in pairs within the attachment, adapting to the specific task of either reducing or expanding the surface area of sheet metal. This flexibility not only enhances the tool's functionality but also enables novel and unexpected results in specific applications, as illustrated schematically in FIGS. 16 and 17.

In the shrinking mode, the shrink or stretch dies 100 typically feature a stippled hardened shrinking die 105. The stippled surface grips and compresses the metal, reducing its area and creating concave shapes. When used in a paired configuration, the dies work in unison to apply controlled pressure to both sides of the sheet metal, ensuring uniform and precise compression. The operation is actuated by a hardened steel rod roller 104, which pushes the dies together under controlled pressure. A bottoming plate for bottom die 102 provides stability, while foam spring material 103 ensures smooth operation and minimizes vibrations during the high-frequency impacts of the planishing hammer 30.

For stretching operations, the shrink or stretch dies 100 can include smooth dies or, in some cases, stippled dies that yield unexpected and advantageous results. The first embodiment of a stretching die 101 employs a smooth surface to prevent tearing or marking the metal, allowing for controlled expansion to create convex shapes. When used singularly or in pairs, these dies are actuated by the same hardened steel rod roller 104, which pushes the dies apart to stretch the metal uniformly. As in the shrinking process, a bottoming plate for bottom die 102 and foam spring material 103 ensure stability and precision.

An unexpected result can be achieved when stippled dies, such as the stippled hardened shrinking die 105, are used singularly in the stretching process. In specific scenarios, the stippled surface introduces controlled texture to the stretched metal, enhancing grip for subsequent operations or creating unique surface finishes. This novel application of stippled dies in stretching expands the tool's versatility and provides creative opportunities for advanced metalworking.

The second embodiment of a stretching die 106 introduces a design optimized for specialized applications, incorporating a bottom stippled hardened stretching die 110. In this configuration, the hardened steel rod roller 109 pushes the dies apart, facilitating precise metal expansion. The top die mirrors the bottom die in design and is secured with a top backing plate and retaining clip, ensuring alignment and consistent performance. The assembly is further stabilized by a bottoming plate 107 and foam spring material 108, which reduce vibration and maintain uniform pressure distribution.

Whether used singularly or in pairs, the shrink or stretch dies 100 enable seamless transitions between shrinking and stretching operations. The universal design allows operators to tailor the configuration to their specific needs, maximizing the tool's adaptability. The novel use of stippled dies in stretching operations adds an element of unpredictability and creativity, enabling results that exceed the expected capabilities of conventional tools.

As shown in FIGS. 16 and 17, the die mechanisms integrate seamlessly with the shrinker/stretcher attachment 90, leveraging the attachment's universal interface 50 for secure installation. The combination of robust materials, precision engineering, and the ability to achieve unexpected outcomes makes the shrinker/stretcher attachment 90 a transformative tool for shaping complex curves and contours in sheet metal. This adaptability ensures its utility across a wide range of professional and creative metalworking applications.

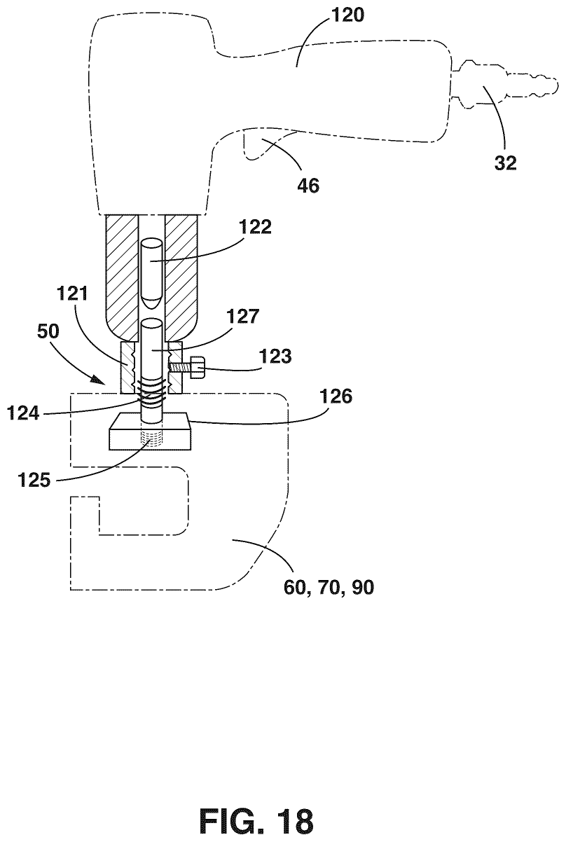

The present invention includes an alternative configuration for the modular attachments, allowing them to interface seamlessly with a pistol-style air hammer/chisel 120. This configuration, illustrated in FIG. 18, provides additional flexibility by enabling the use of the stepper 60, the flanger 70, and the shrinker/stretcher 90 attachments with a compact, handheld power source. The integration of the modular attachments with the air hammer/chisel 120 expands their utility across a range of applications while maintaining precision and efficiency.

The attachment interface for the air hammer/chisel 120 includes a collar or threaded coupler 121, which securely connects the modular attachment to the tool. The coupler is designed for quick installation and removal, allowing the operator to switch between attachments without the need for specialized tools. This threaded connection ensures a stable and reliable link, even during high-frequency impacts generated by the air hammer's operation.

The driving force for the attachments is provided by the hammer chisel air piston 122, which is actuated by compressed air. The piston delivers consistent, high-speed impacts to the modular attachments, enabling precise performance in stepping, flanging, shrinking, and stretching tasks. The system is further stabilized by a locking screw 123, which secures the modular attachment in alignment with the hammer's striking axis, preventing misalignment during operation.

To ensure smooth operation and reduce wear on the components, the interface incorporates a return spring 124, which resets the position of the hammer mechanism after each strike. This spring absorbs excess energy from the impacts, minimizing vibrations and enhancing the operator's control over the tool. The spring also contributes to the longevity of the interface by mitigating the mechanical stresses exerted on the components.

A threaded rod end 125 is used to anchor the modular attachment securely to the air hammer/chisel 120, maintaining consistent alignment. The hammer face 126 serves as the contact point for transmitting the force from the air piston to the modular attachment. This hammer face is constructed from durable materials to withstand the repeated impacts and ensure reliable performance.

The interface is supported by a ram rod 127, which channels the force from the hammer piston to the modular attachment. The ram rod 127 is precisely aligned to ensure the energy is transferred efficiently and without deviation, allowing for accurate and consistent operation of the modular tools.

The ability to integrate the stepper 60, flanger 70, and shrinker/stretcher 90 attachments with the pistol-style air hammer/chisel 120 enhances the versatility of the system by offering a portable and powerful alternative to conventional planishing hammer setups. The threaded coupler 121 and locking screw 123 ensure ease of attachment while maintaining stability, even during demanding operations. This configuration provides metalworkers with the flexibility to choose between a unitized construction with a power source or a modular system compatible with existing tools, addressing the diverse needs of professional and hobbyist users alike.

To use the modular attachments, the operator first selects the appropriate attachment for the desired operation and secures it to the handheld planishing hammer 30 or air hammer chisel 120 using the attachment interface 50. Once installed, the operator adjusts the attachment's settings, such as depth or angle, to match the material thickness and operation requirements. The planishing hammer 30 or air hammer chisel 120 is then operated as usual, with the attachment guiding the hammer's 30, 120 strikes to perform its designated function. If a different operation is required, the quick-release mechanism allows the operator to replace the attachment swiftly, minimizing downtime and enhancing workflow efficiency.

The modular attachments described in this invention offer several key advantages. By expanding the range of operations a planishing hammer 30 or air hammer chisel 120 can perform, the attachments enhance the tool's versatility and utility. The quick-swap system reduces downtime and simplifies transitions between tasks, improving overall efficiency. The specialized designs of the stepper 60, flanger 70, and shrinker/stretcher 90 attachments ensure consistent and accurate results, even for intricate operations. Furthermore, the attachment interface 50 makes the system adaptable to a wide variety of planishing hammers 30 or air hammer chisels 120, while the lightweight and portable design ensures suitability for both workshop and on-site use.

The modular attachments are applicable to a wide range of industries and crafts, including automotive restoration, aerospace component fabrication, jewelry making, architectural metalworking, and artistic metal sculpture. By addressing the limitations of conventional planishing hammers 30 and air hammer chisels 120, this invention provides a versatile, efficient, and precise solution for modern metalworking needs.

It should be noted. The present invention is described in the previous examples, which are set forth to aid in the understanding of the invention. and should not be construed to limit in any way the scope of the invention as defined in the claims which follow thereafter.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A modular attachment system for use with a planishing hammer or air-powered chisel, comprising:
an attachment interface configured to securely connect modular attachments to the planishing hammer or air-powered chisel;
a stepper attachment configured to create stepped profiles in sheet metal, the stepper attachment including a ridged die configured to deform sheet metal into stepped profiles, an adjustable edge depth guide to control the depth of the stepped profiles, and a housing configured to support and align the stepper attachment during operation;
a flanger attachment configured to form flanges in sheet metal, the flanger attachment including curved dies of varying radii to create flanges of different sizes and angles, a rotary guide rail mechanism to guide the sheet metal during the flanging process, and an adjustable angle mechanism for controlling the angle of the flanges; and
a shrinker/stretcher attachment configured to modify the surface area of sheet metal, the shrinker/stretcher attachment including interchangeable dies configured to shrink or stretch the sheet metal, a quick-swap mechanism for replacing the dies between shrinking and stretching configurations, and a support assembly comprising a housing plate and retaining components to secure the dies during operation.

2. A modular attachment system for use with a planishing hammer or air-powered chisel, comprising:
an attachment interface configured to securely connect modular attachments to the planishing hammer or air-powered chisel;
modular attachments including a stepper attachment configured to create stepped profiles in sheet metal, the stepper attachment including adjustable components for varying step depth and die configurations;
a flanger attachment configured to create flanges in sheet metal, the flanger attachment including mechanisms for precise alignment and adjustable stops for consistent flange formation; and
a shrinker/stretcher attachment configured to compress or expand sheet metal, the shrinker/stretcher attachment including interchangeable dies and a quick-change mechanism;
wherein the attachment interface is configured to maintain alignment and stability during high-frequency operation of the planishing hammer or air-powered chisel.

3. The modular attachment system of claim 1, wherein the attachment interface includes a locking mechanism configured to accommodate variations in the size and shape of the hammer or chisel head.

4. The modular attachment system of claim 1, wherein the attachment interface further comprises vibration-dampening elements to reduce wear and improve stability during operation.

5. The modular attachment system of claim 1, wherein the stepper attachment further comprises a pressure plate configured to prevent unintended deformation of the sheet metal during operation.

6. The modular attachment system of claim 1, wherein the stepper attachment further comprises an adjustable depth anvil guide configured to fine-tune the position of the anvil relative to the sheet metal.

7. The modular attachment system of claim 1, wherein the flanger attachment further comprises a spring-loaded adjusting pin for precision alignment of the rotary guide rail mechanism.

8. The modular attachment system of claim 1, wherein the flanger attachment further comprises a bending plate with a solid edge for consistent flange formation.

9. The modular attachment system of claim 1, wherein the flanger attachment includes a replaceable insert made of a resilient material to protect the sheet metal during operation.

10. The modular attachment system of claim 1, wherein the shrinker/stretcher attachment further comprises foam spring material to provide controlled resistance and reduce vibrations during operation.

11. The modular attachment system of claim 1, wherein the shrinker/stretcher attachment further comprises a stippled die configured to introduce controlled texture to the metal surface during stretching operations.

12. The modular attachment system of claim 1, wherein the attachment interface is configured to allow modular attachments to be rotated about the hammer or chisel axis for operation in confined spaces.

13. The modular attachment system of claim 1, wherein the stepper attachment includes interchangeable dies to create stepped profiles of varying dimensions.

14. The modular attachment system of claim 1, wherein the flanger attachment includes adjustable stops for producing flanges with uniform dimensions across multiple operations.

15. The modular attachment system of claim 1, wherein the shrinker/stretcher attachment is configured to use the dies singularly or in pairs for varied applications.

16. The modular attachment system of claim 2, wherein the modular attachments are constructed as a unitized system integrated with a power source for standalone operation.

17. The modular attachment system of claim 2, wherein the attachment interface is equipped with self-centering guides to ensure precise alignment with the hammer or chisel.

18. The modular attachment system of claim 2, wherein the attachment interface includes a quick-release mechanism to enable rapid switching between modular attachments.

19. The modular attachment system of claim 1, wherein the modular attachments are compatible with handheld planishing hammers, stationary planishing hammers, and pistol-style air-powered chisels.

20. The modular attachment system of claim 1, wherein the shrinker/stretcher attachment further includes a mechanism for aligning the top and bottom dies to prevent misalignment during high-frequency operation.
